(19) United States
(12) Patent Application Publication
(10) Pub. No.: US 2010/0065044 A1
(43) Pub. Date: Mar. 18, 2010

(54) SOLAR THERMAL PANEL AND METHOD OF MANUFACTURE

(75) Inventors: John Edward Hubbard Reader, Suffolk (GB); David John Buckles, Suffolk (GB); Nicolas Brooks, Leicestershire (GB); Andrew Jones, Leicestershire (GB)

Correspondence Address: Leason Ellis LLP, 81 Main Street, Suite 503, White Plains, NY, 10601, US

(73) Assignee: G.A.H. Heating Products , Ltd., Suffolk (GB)

(21) Appl. No.: 12/482,715

(22) Filed: Jun. 11, 2009

(30) Foreign Application Priority Data
Dec. 12, 2006 (GB) 0624780.3
Dec. 12, 2007 (GB) PCT/GB2007/004763

(51) Int. Cl. F24J 2/48; B23P 15/26

(52) U.S. Cl. 126/676; 29/890.033

(57) ABSTRACT

A solar thermal panel is disclosed. The solar thermal panel includes a body, the body comprising a plurality of rubber particles bound by a binding agent and defining one or more channels within the body, the or each channel including a fluid inlet and a fluid outlet connectable to a fluid circulation circuit.

### FIELD OF THE INVENTION

The present invention relates to solar thermal panels that are particularly applicable for use in low cost, roof mounted systems for domestic water heating and/or generating electricity.

### BACKGROUND TO THE INVENTION

Solar Thermal panels absorb solar radiation directly and use this to heat either air or water. Two types of solar thermal systems are commonly used:

Evacuated tubes and flat panels.

Flat panel systems are generally less costly per unit area but are typically 15-30% less efficient compared to evacuated tube systems. The typical cross section for a flat panel system is shown in FIG. 1. The solar radiation is absorbed by the selective coating and the thermal energy then transferred along the heat transfer plate and used to heat the water that circulates in the water pipes. The panels are typically mounted in an aluminium housing with thermal insulation provided by the glazing on the top surface and foam insulation on the under surface.

Current flat panel solar thermal systems lose heat during thermal conduction along the heat transfer plates, this is the main cause of low efficiency. Flat plate systems have almost reached the limit of their efficiency, and only small steps are expected beyond current efficiency levels. However the current systems are relatively expensive, with a payback period of ˜12-15 years. This cost is due to the high costs of both the manufacturing and installation. The high manufacturing costs are due to the labour intensive nature of the manufacturing process that uses traditional metal working technologies and assembly techniques. Typical flat panel solar thermal costs are £2,000-£3,000. For example Solartwin (2.8 sq.m) panel system costs £2,499. The high installation costs come from the need to mount the current systems securely on the sloping parts of house roofs (requiring skilled roofers) and the complexity of the plumbing requiring skilled plumbers as well. Typical installation costs are ˜£800-£1,000 (2 skilled people for one day).

The main alternative to the flat panel technology is the use of evacuated tubes, shown in cross section in FIG. 2. The evacuated tubes have a higher efficiency (up to 90%) due to the reduction of heat losses by conduction and convection. However, evacuated tube systems are prohibitively expensive, typically costing in the region of £3,500-£4,500 and their lifetime is limited as they only maintain vacuum for a limited period of time. Recently solar thermal tiles, such as C21t produced by Solar Century have been launched onto the market. However these are again very expensive and require highly skilled roofers to fit them. In addition, if they leak then the leakage will be internal to the house structure and may cause damage.

Solar electric panels operate in a similar manner but convert the captured solar energy to electricity. They too suffer similar constructional problems as those identified above for solar thermal panels.

### STATEMENT OF INVENTION

According to an aspect of the present invention, there is provided a solar thermal panel including a body, the body comprising a plurality of rubber particles bound by a binding agent and defining one or more channels within the body, the or each channel including a fluid inlet and a fluid outlet connectable to a fluid circulation circuit.

Each rubber particle may comprise a rubber crumb. Preferably, the rubber crumb comprises recycled rubber tyre material.

Preferably, each rubber crumb is approximately 2 mm to 5 mm in diameter.

The plurality of rubber particles may be distributed substantially uniformly within the body.

The binding agent may include a thermoplastic.

The solar panel may further comprise a solar absorbing layer covering a solar ray receiving surface of the body.

According to another aspect of the present invention, there is provided a method of manufacturing a solar thermal panel comprising pressure moulding a mixture of rubber particles and a binding agent into a body, the method including forming one or more channels within the body and forming a fluid inlet and a fluid outlet for each channel for connection to a fluid source external of the body.

The step of pressure moulding may comprise compression moulding or injection moulding.

The method may further comprise obtaining the rubber particles from crumbed recycled rubber tyres.

The binding agent may include a thermoplastic, the method further comprising heating the mixture of rubber particles and binding agent to bind the rubber particles within a thermoplastic matrix.

The method may further comprise moulding the body in a single piece.

The method may further comprise applying a solar absorbing sheet to an exterior surface of the body.

The step of applying the solar absorbing sheet may include inserting the sheet in a mould for pressure moudling of the body prior to said pressure moulding.

In one embodiment of the present invention, the panels may form a roof mountable solar panel comprising a ridge for installation on a roof, at least a part of one of the surfaces of the ridge comprising a body, the body comprising a plurality of rubber particles bound by a binding agent and defining one or more channels within the body, the or each channel including a fluid inlet and a fluid outlet connectable to a fluid circulation circuit.

Preferably, first and second panel pieces meet to form the ridge, at least one of the two panel pieces including or mounting the solar panel.

Preferably, the first and second panel pieces are hinged together to form the ridge. By forming the solar panel as a ridge, its geometry assists installation on a roof as it can be positioned spanning the roof apex and at any other position where there is a sufficient ridge (such as the edge or hips of a roof). Once in position, only a limited amount of securement is necessary to ensure the panel stays in place.

In one embodiment, the solar panel may be provided as a kit, the first and second panel pieces being joinable during installation to form the ridge.

In contrast to the prior art, the solar panel will be mounted onto the roof apex, rather than being mounted onto the sloping side of the roof (usually south-facing). This factor will greatly simplify the installation process. The hinging of the ridge panels will allow them to be fitted to roofs of any apex angle easily and with an equal weight distribution, thus reducing the current stringent mounting requirements, and also reducing installation time and cost. Previous work by the Environmental Change Institute (University of Oxford) has shown that even East or West facing roofs achieve 80% of peak energy output of that for the south-facing panels. Therefore it is expected that mounting on the apex will still be highly effective.

In a preferred embodiment, the or each panel, or parts thereof, may be formed from injection moulded thermoplastics. This removes the need for thermal conduction along heat transfer plates. Preferably, the thermoplastics are selected to have high thermal absorption characteristics (such as black colouring). Such an arrangement will allow the maximisation of the solar radiation absorption area, thus maximising the solar energy absorbed. In addition, the radiation absorbing surfaces will be in direct contact with the flowing water, minimising thermal conduction losses and increasing efficiency.

It is believed that such a change in design to that of the conventional flat panel solar thermal system known in the art will result in a significant reduction in manufacturing and installation costs.

These and other aspects and features of the invention can be further appreciated from the accompanying drawing figures and detailed discussion of certain embodiments of the invention.

### BRIEF DESCRIPTION OF THE DRAWINGS

Embodiments of the present invention will now be described in detail by way of example only, with reference to the accompanying drawings in which:

FIG. 1 is a cross section of a conventional flat panel system;

FIG. 2 is a cross section of a conventional evacuated tube system;

FIG. 3a is a schematic diagram of an embodiment of the present invention;

FIG. 3b is a schematic diagram of an injection moulding system suitable for use in forming the embodiment of FIG. 3a;

FIG. 4 is a perspective view of an embodiment of the present invention;

FIG. 5 is a cross section of a panel of the embodiment of FIG. 4;

FIG. 6 is an exploded view of a kit according to an embodiment of the present invention;

FIG. 7 is a perspective view of the kit of FIG. 6 in use.

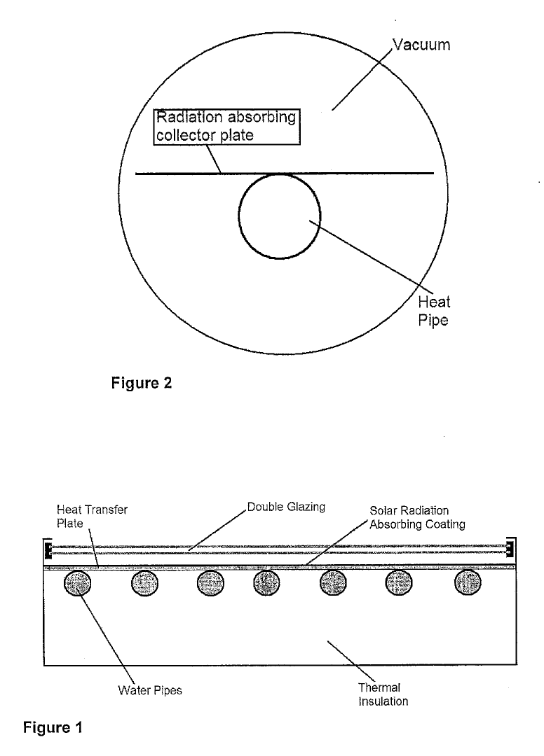

### DETAILED DESCRIPTION OF CERTAIN EMBODIMENTS OF THE INVENTION

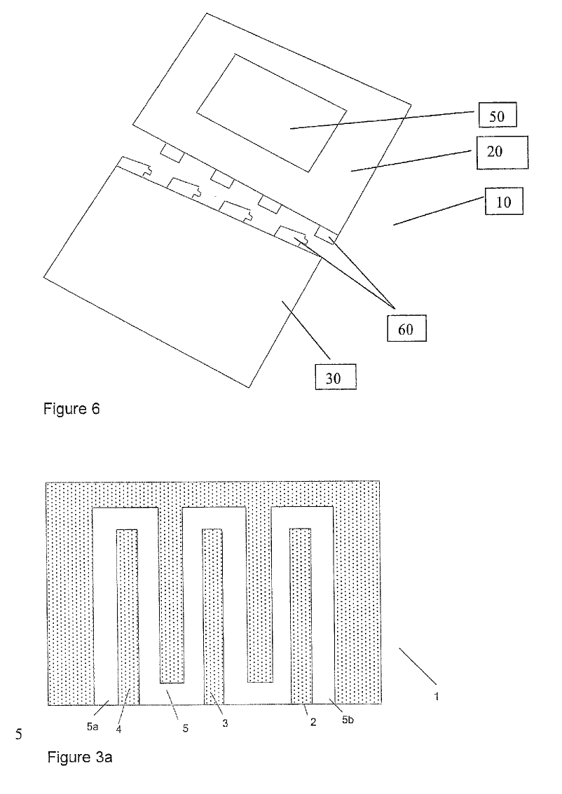

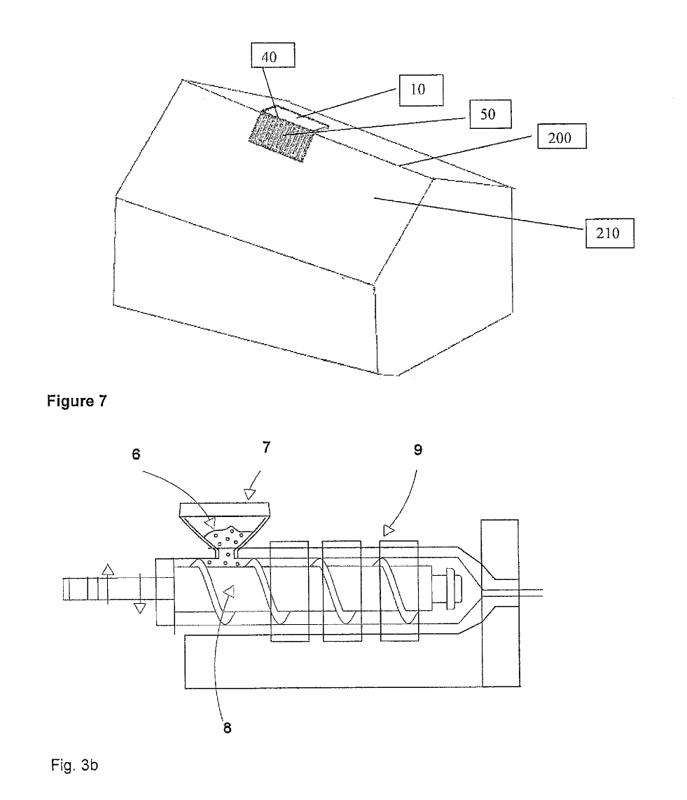

FIG. 3a is a schematic diagram of a solar thermal panel according to an embodiment of the present invention. The solar thermal panel 1 comprises a body 2 formed from rubber particles 3 bound by a binding agent such as a thermoplastic material 4 (referred to as the “matrix”). The body 2 includes one or more fluid channels 5. The distribution of particles in the matrix is illustrated as being uniform and this is desirable where uniform energy absorption and structural integrity is required; However, non uniform distribution may be beneficial in some cases where the differing physical properties of the matrix and rubber particles could be harnessed advantageously to provide additional features relating to functionality or strength.

The or each fluid channel includes a fluid inlet 5a and a fluid outlet 5b for connection to a fluid circulation circuit 5c.

Preferably, the rubber particles 3 comprise a rubber crumb material. Most preferably, the source of the rubber crumb is recycled tyres.

The fluid channel(s) 5 may accommodate air, water or some other heat transfer fluid. In a typical arrangement, the fluid would be pumped or otherwise driven around the fluid circulation circuit. As the fluid passes through the channel or channels, it absorbs heat from both solar rays and from that previously absorbed by the matrix. At some point in the circuit, the fluid passes through a heat exchanger and the absorbed heat is extracted (for use in heating etc).

The rubber particle based body is advantageous in this use because it is able to absorb significant amounts more heat than a standard plastics based body without significantly affecting the structural integrity of the panel. Additionally, the material is cheap, lightweight and formed from predominantly recycled materials.

As the rubber cannot be melted, the crumb is bound together using a binding agent to give the necessary physical properties needed for the panel. Preferably, the binding agent includes a thermoplastic. Most preferably, the binding agent includes polypropylene. The thermoplastic selected needs good functionality with the rubber and good heat stability. The interface between rubber and polypropylene should also be designed to avoid fluid leakage from the channels.

The body is preferably formed by a pressure moulding process such as compression moulding or injection moulding. Preferably, injection moulding is used.

In the case of compression moulding, the thermoplastic material would be mixed with the rubber particles and heated prior to moulding. A discrete shot of material is weighed out and then compressed in a mould.

In a pressure moulding process where melting the thermoplastic may be difficult, a more conventional adhesive binder could be used.

FIG. 3b is a schematic diagram of an injection moulding system suitable for use in forming the embodiment of FIG. 3a;

Preferred embodiments of the present invention comprise injection moulding of the thermoplastic material mixed with the rubber particles. The mixture 6 is passed into a hopper 7 and then into a screw (or ram) type plunger 8. Heat is applied to the mixture 6 by a heat source 9 and by shear created by mechanical action. The heated mixture is the injected into an appropriate mould (not shown).

It may be possible to dose the materials separately depending on the injection moulding unit.

Injection moulding gives very good design flexibility. Preferably, the panel is moulded in one piece with the channels integral. This removes the need to have to join two half shells together. As there is no joint, the potential for leakage through a joint will also be negated. Although more difficult than moulding half shells, this is not a challenging application for injection moulding.

Preferably the ratio by weight of rubber tyre crumb to thermoplastic is 3:1. It will be appreciated that the exact ratio will depend on many factors such as cost, particle size of the crumb, binding agent, intended environment of use, and design of the panel. Ratios of 10 or even 20:1 up to 1:1 are possible.

Rubber tyre crumb particles of approximately 2 mm to 5 mm in diameter are preferred although this is not essential. An approximate diameter (as it will be appreciated that the particles may not be of a uniform or regular shape) of anything between 150 micro metres and 5 mm or more could be used.

The body 2 may optionally be covered with a solar absorbing sheet such as Tinox®. An Ultra Violet (UV) light absorbing transparent Polymethyl Methacrylate (PMMA) or Polycarbonate with a UV absorbent top layer may also be placed over the panel. Preferably, this will contain additives to prevent environmental attack and degradation to weathering protection and thermal insulation. The sheet will also preferably be treated to be self cleaning and prevent growth such as algae.

The solar radiation absorption sheet is preferably inserted in the injection mould tool prior to injection of the rubber filler thermoplastic and overmoulded using in-mould lamination techniques to give adherence to the base layer.

It will be appreciated that the materials and production techniques discussed could be used for any size, shape of configuration of solar thermal panel which is apex mounted or otherwise (such as a single panel mounted in a conventional manner on a slope of a roof).

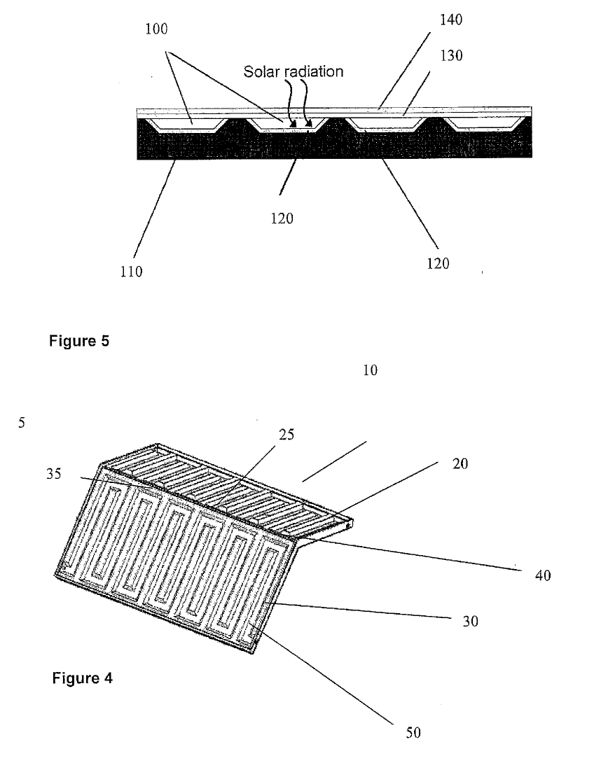

FIG. 4 is a perspective view of an embodiment of the present invention, FIG. 5 is a cross section of a panel of the embodiment of FIG. 4, FIG. 6 is an exploded view of a kit according to an embodiment of the present invention and FIG. 7 is a perspective view of the panel of FIG. 4 in use.

The solar panel 10 includes first 20 and second 30 panel pieces that are joined along one side 25, 35 to form a ridge 40. A solar energy collector 50 is mounted or integrated into one or both panel pieces. The solar energy collector 50 need not occupy the whole of a panel piece.

Preferably, the first 20 and second 30 panel pieces are joined via a hinge 60 (the parts of which are shown in FIG. 6). The hinge 60 may be integral to the panel parts (such as part of the moulding) or it may be a separate component fixed to the panel parts 20, 30.

By joining the panel parts 20, 30 together using a hinge 60, the angle of the ridge can be adjusted to suit the particular application/roof apex. The hinge may be secured via some form of pin or other mechanism.

Most preferably, the two panel parts 20, 30 slot together on installation.

The solar energy collector 50 may be a solar thermal panel (as illustrated in FIGS. 4, 5 and 7), a solar electric panel (such as a photo-voltaic system as illustrated in FIG. 6) or any other solar energy collection system

The panels will preferably have optimal geometry for solar radiation absorption, heat transfer and, where necessary, water flow. This will be achieved by utilising optimal thermal design in combination with flexible processing methods. A preferred solar thermal panel design in cross-section is shown in FIG. 4 in which:
A plurality of fluid flow channels 100 are formed in a thermally insulating material 110 such as a rubber crumb/thermoplastic base;
The base 110 is then optionally covered with a solar absorbing sheet 120 such as Tinox®;
An Ultra Violet (UV) light absorbing transparent Polymethyl Methacrylate (PMMA) or Polycarbonate 130 with a UV absorbent top layer 140 is then preferably placed over the panel. Preferably, this will contain additives to prevent environmental attack and degradation to weathering protection and thermal insulation. The sheet will also preferably be treated to be self cleaning and prevent growth such as algae.

It will be appreciated that other materials may be used depending on the solar energy collector and indeed any type of solar energy collector may be used and either integrated into the panel piece during manufacture or attached prior to or during installation.

Subject to optimal selection of the thermoplastic base, the solar absorbing sheet may not be necessary. For example, it has been found that a rubber tyre crumb filled thermoplastic matrix, preferably which is black, absorbs a significant amount of heat such that the solar absorbing sheet is unnecessary.

As illustrated in FIG. 6, the panels preferably are supplied in kit form for ease of installation. To keep installation and the system as simple as possible, the generated energy and fluid flow may be separate in the two panels (where a solar energy collector is present on both panels).

### Panel Design:

The panels will preferably consist of two parts joined by a hinging mechanism, that will allow the panel to be mounted directly onto the roof of a house with any apex angle.
Individual panels, that will be easily handleable, will be connected to produce a complete unit.
The panels will be preferably designed to maximise the area of the solar radiation absorbing layer. This layer is directly in contact with the circulating water. This will simultaneously maximise the solar energy absorbed (which is directly proportional to the area) and minimise the thermal losses due to thermal conduction.
It is expected that the panels will have >20-year service life.

### Panel Manufacture:

The base layer will preferably be injection moulded using a rubber tyre crumb filled thermoplastic matrix.
The solar radiation absorption layer (a material such as Tinox®) will be preferably inserted in the injection mould tool prior to injection of the rubber filler thermoplastic and overmoulded using in-mould lamination techniques to give adherence to the base layer.
If the two panels are to share the heat collection fluid, water connectors between each of the panels will be preferably inserted into the moulds before injection and over moulded.

### Panel Installation:

The hinged panels will be mounted onto the apex 200 of the roof 210 as is shown in FIG. 7. They are then secured by securement means (for example screws into the roof structure, clamps onto adjacent ridge tiles etc). The panel pieces will be simply connected together to give the complete flow path and then plumbed into the building's hot water system. Due to the light weight of the panels and their ease of installation, they can be fitted simply and quickly. Panels may be installed on top of or in replacement for existing ridge tiles.

It should be understood that various combination, alternatives and modifications of the present invention could be devised by those skilled in the art. The present invention is intended to embrace all such alternatives, modifications and variances that fall within the scope of the appended claims.

1. A solar thermal panel including a body, the body comprising a plurality of rubber particles bound by a binding agent and defining one or more channels within the body, the or each channel including a fluid inlet and a fluid outlet connectable to a fluid circulation circuit.

2. A solar thermal panel as claimed in claim 1, wherein each rubber particle comprises a rubber crumb.

3. A solar thermal panel as claimed in claim 2, wherein the rubber crumb comprises recycled rubber tyre material.

4. A solar thermal panel as claimed in claim 2, wherein each rubber crumb is approximately 2 mm to 5 mm in diameter.

5. A solar thermal panel as claimed in claim 1, wherein the plurality of rubber particles are distributed substantially uniformly within the body.

6. A solar thermal panel as claimed in claim 3, wherein the binding agent includes a thermoplastic.

7. A solar thermal panel as claimed in claim 1, further comprising a solar absorbing layer covering a solar ray receiving surface of the body.

8. A method of manufacturing a solar thermal panel comprising pressure moulding a mixture of rubber particles and a binding agent into a body, the method including forming one or more channels within the body and forming a fluid inlet and a fluid outlet for each channel for connection to a fluid source external of the body.

9. A method as claimed in claim 8, wherein the step of pressure moulding comprises compression moulding.

10. A method as claimed in claim 8, wherein the step of pressure moulding comprises injection moulding.

11. A method as claimed in claim 9, further comprising obtaining the rubber particles from crumbed recycled rubber tyres.

12. A method as claimed in claim 8, wherein the binding agent includes a thermoplastic, the method further comprising heating the mixture of rubber particles and binding agent to bind the rubber particles within a thermoplastic matrix.

13. A method as claimed in claim 8, further comprising moulding the body in a single piece.

14. A method as claimed in claim 8, further comprising applying a solar absorbing sheet to an exterior surface of the body.

15. A method as claimed in claim 14, wherein the step of applying the solar absorbing sheet includes inserting the sheet in a mould for pressure moudling of the body prior to said pressure moulding.

16. A roof mountable solar thermal panel comprising a ridge for installation on a roof, at least a part of one of the surfaces of the ridge comprising a body, the body comprising a plurality of rubber particles bound by a binding agent and defining one or more channels within the body, the or each channel including a fluid inlet and a fluid outlet connectable to a fluid circulation circuit.

17. A roof mountable solar thermal panel as claimed in claim 16, further comprising first and second panel pieces meeting to form the ridge, wherein at least one of the two panel pieces comprises said body.

18. A roof mountable solar thermal panel as claimed in claim 17, wherein the first and second panel pieces are hinged together to form the ridge.

19. A roof mountable solar thermal panel as claimed in claim 17, wherein the first and second panel pieces are separable and arranged to mate during installation to form the ridge.
